(19) United States
(12) Patent Application Publication
(10) Pub. No.: US 2005/0287035 A1
(43) Pub. Date: Dec. 29, 2005

(54) Electrode strips for testing small volumes

(76) Inventors: Bernadette Yon-Hin, Cambridge (GB); Stephen Charles Williams, El Granada, CA (US); Neil Blair, Hardwick (GB); James McCann, Cambridge (GB); Lorna Jean Cox, Cambridge (GB)

Correspondence Address: George W. Rauchfuss, Jr., Esq.;Ohlandt, Greeley, Ruggiero & Perle, L.L.P., 10th Floor, One Landmark Square, Stamford, CT, 06901-2682, US

(21) Appl. No.: 11/022,626

(22) Filed: Dec. 27, 2004

(30) Foreign Application Priority Data
Jun. 4, 1997 (GB) 9711395.5
Nov. 11, 1998 (GB) 9824627.5

(51) Int. Cl. G01N 31/22

(52) U.S. Cl. 422/56

(57) ABSTRACT

A test strip for testing small volumes in which a layer of mesh or membrane material is provided, in which a small volume of liquid to be tested can be distributed and provide contact between an active electrode and counterelectrode on a support, and wherein an analyte-specific reagent is coated on the mesh or material or one of the electrodes, and in which the sample application area is at one edge of the mesh or membrane.

### CROSS-REFERENCE TO RELATED APPLICATIONS

This Application is a continuation of application Ser. No. 09/445,154, filed Mar. 6, 2000, and of PCT/GB99/03764, filed Nov. 11, 1999.

### FIELD OF THE INVENTION

This invention relates to electrode strips for testing small volumes of, say, whole blood.

### BACKGROUND OF THE INVENTION

Diabetes is one of the most common endocrine condition. Sufferers must monitor their blood glucose level frequently. This is usually achieved by the use of small test strips which detect blood glucose.

Problems commonly experienced by users of these test strips include an inadequate amount of blood on the test strip and bad placement of the blood on the test strip. A number of devices have addressed this problem, by using sample chambers that fill by capillary action. The sample is retained in close proximity to the electrodes which facilitate the measurement of the specific analyte in the sample see EP-A-0170375 and U.S. Pat. No. 5,141,868.

Such known devices comprise electrodes deposited on a non-conducting substrate, coated with a reagent system specific for the analyte of interest and housed within a cavity who dimensions are sufficiently small to allow introduction of a sample, e.g. 2.5-3 μL in volume, by capillary action. The sample is retained in close proximity to the electrodes, and the electrodes are configured in such a way as to facilitate the measurement of specific electrical properties of the sample.

Such devices suffer from numerous drawbacks, in particular the need to control the dimensions of the cavity within very tightly defined limits. Exceeding these manufacturing tolerances will prevent the sample from entering the cavity by capillary action. In particular, the extent to which these devices can be miniaturized is limited by both the manufacturing tolerances and the signal-to-noise ratio achievable with the relevant chemistry.

Further, when viscous sample fluids such as blood are introduced into the cavity, the chamber will fill with sample relatively slowly, thus delaying the time taken to complete the analysis. Variations in sample viscosity and thus sample surface tension characteristics result in variations of the fill time; this not only compromises the overall analysis time but, more importantly, leads to imprecision in the analytical result, since the time over which the sample is exposed to the analyte-specific reagent is subject to variation.

Another common problem with these tests is that the response of the systems changes, due to changes in the haematocrit levels of the blood. Typically, the red blood cells may change the viscosity of the sample or otherwise hinder the performance of the test. These changes, which are usually not related to the analyte level, interfere with the test. In extreme cases, they may make large changes to the response of the device and give the user seriously misleading results. Particularly misleading results can be obtained for neonates and those suffering from blood disorders.

WO-A-9730344 discloses an electrode device which includes a polyester mesh adapted to guide the sample to the reference electrode. This device requires that the reagent includes a filler having both hydrophobic and hydrophilic surface regions, in order to avoid problems associated with variations in sample handling and to be independent of the haemocrit of the sample, for glucose testing.

U.S. Pat. No. 5,820,551 discloses a test strip comprising a support carrying a working electrode and a counter electrode, and an enzyme and a mediator that are coated on the active electrode. A drop of whole blood can provide a conducting path between the electrodes, and the concentration of glucose in the blood can be determined. The active electrode is exposed to a whole blood sample without an intervening membrane or other whole blood filter.

U.S. Pat. No. 5,628,990 discloses a conductive layer coated with an analyte specific reagent and deposited on a non-conducting substrate, a spacer layer deposited onto the non-conducting substrate by thick film printing, a monofilament mesh material coated with a surfactant and/or a chaotropic reagent, the mesh being overlaid onto the space layer and a second non-conductive substrate adhered to the mesh layer. The device is thus multilayer in construction, and comprises two surfaces separated by a printed spacer layer and forming a cavity or area which is open at one end for the introduction of sample. This cavity or area is filled with a mesh material that extends beyond the second substrate and forms a sample application area.

### SUMMARY OF THE INVENTION

According to one aspect of the present invention, a device which is capable of electrochemical measurement of the levels of analytes present in a small fluid sample volume, comprises a conductive layer coated with an analyte-specific reagent and deposited on a non-conducting substrate, a spacer layer deposited onto the non-conducting substrate by thick film printing, a monofilament mesh material coated with a surfactant and/or a chaotropic reagent, the mesh being overlaid onto the space layer, and a second non-conductive substrate adhered to the mesh layer. The device is thus multi layer in construction, and comprises two surfaces separated by a printed spacer layer and forming a cavity or area which is open at one end for the introduction of sample. This cavity or area is filled with a mesh material that extends beyond the second substrate and forms a sample application area.

According to a further aspect of the present invention, a test strip comprises a support carrying an active electrode and a counterelectrode, and a layer of a material within which a small volume of liquid to be tested can be distributed and provide contact between the electrodes, and wherein an analyte-specific reagent such as one component of a redox reaction, e.g. an enzyme, co-factor or mediator, is coated on the material. In particular, the invention provides a test strip for blood glucose, in which the sample requirement is very small, and efficient reaction kinetics are achieved by the application of the reagents in a novel manner.

The reagent-coated material may itself be in tape form. According to yet another aspect of the invention, a flexible tape is of a material within which liquid can be distributed and on which are coated discrete areas of at least one component of a redox reaction.

By way of example only, a device according to the present invention may be produced and used by a procedure involving one or more. e.g. all of the following steps:
(a) depositing a conducting layer of carbon and graphite, in a polymer binder, on a first non-conducting substrate;
(b) depositing a second conducting layer consisting of silver/silver chloride to function as a reference/counter electrode, adjacent to but not continuous with the first conducting layer;
(c) coating the surface of the first conductive layer with a reagent or mixtures of reagents which react specifically with an analyte or analytes in a sample material;
(d) forming a spacer layer by thick film printing on top of the first non-conducting substrate and on top of the first conducting layer, in order to leave a portion of each of the first and second conducting layers exposed,
(e) locating a coated mesh material on top of the spacer layer and permanently securing it to the spacer layer;
(f) locating a second non-conducting substrate on top of the mesh material and permanently securing it in such a way as to leave an extended area of mesh exposed;
(g) applying a sample to the extended mesh area in order to fill or flood the device sensing area, by wetting of the mesh with sample; and
(h) quantifying the analyte in the sample by reaction with the reagent on the first conducting layer.

The electrode device allows the application of a small volume of sample (typically less than 1 μL) to the mesh extension. Using conventional sensor processing technology, devices may be constructed that require as little as 0.1 to 0.2 μL of sample. This is achieved by flooding of the device sensing area with sample, bringing it into intimate contact with the measuring electrodes. The cavity may be filled either by placing a drop of sample liquid on top of the exposed mesh at the edge of the cavity or by contacting the edge of the cavity with the sample.

Provision of mesh at the edge of the device allows for easy collection of blood from a patient. The nurse or other user can simply hold the device in contact with the patient, and can readily see where to do that, by contrast to any device where the sample application area is not at a peripheral edge. This is an important consideration where a simple test has to be done many times a day, and typically with patients such as children or neonates where simplicity of operation is essential.

### BRIEF DESCRIPTION OF THE DRAWINGS

The accompanying drawings are provided for the purpose of illustration only in the drawings:

FIG. 1A is a schematic side view of a sensor device embodying the present invention; and

FIG. 1B is a plan view of part of the embodiment shown in FIG. 1A

### DESCRIPTION OF THE INVENTION

One characteristic feature of the present invention is the use of a monofilament mesh or membrane material. A sample application area is provided on the mesh.

The mesh layer is preferably a synthetic, monofilament, woven material it may be made from polyester or nylon. The mesh is coated with a surfactant material, a detergent or wetting or lysing agent Examples include fluorosurfactants, non-ionic surfactants, ionic surfactants, zwitterionic surfactants, saponin and sodium cholate. In a preferred embodiment of the invention, as a glycoside agent, digitonin saponin, decanoyl-N-methylglucamide (DNMG) or a combination of saponin and DNMG is used, to lyse the red blood cells in a diagnostic strip.

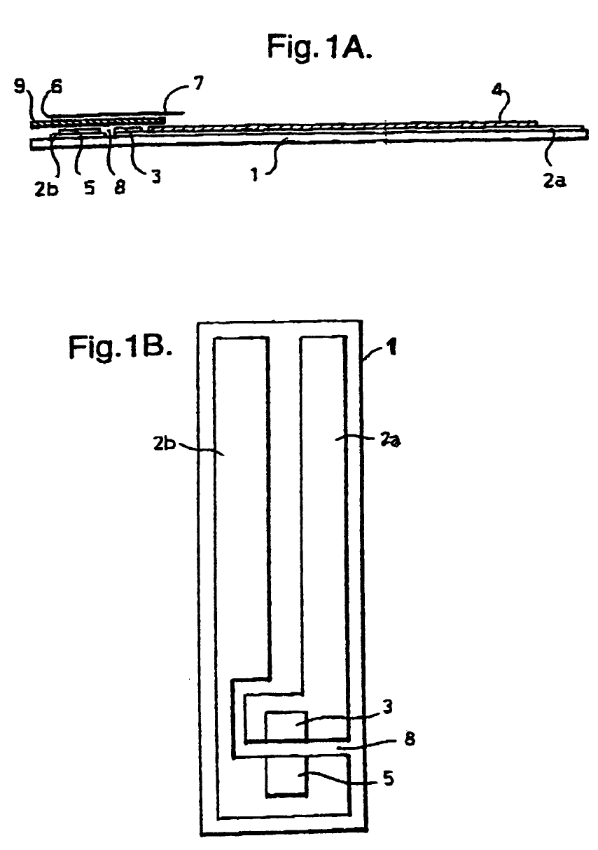

Preferably, the lysing agent should be included in a perforated mesh material that lies above the sensor in the manner of FIG. 1. Red blood cells that come into contact with the lysing agent on the mesh are lysing before they come into contact with the underlying sensor. Alternatively, both the lysing agent and the enzyme may be included in the perforated layer itself by, for example, a spotting or dispensing method as disclosed below.

The mesh material is interposed between the spacer layer (on the first substrate) and the second substrate, and functions to reduce the surface tension and/or viscosity of the sample, e.g by virtue of a wetting agent coated onto its surface. Application of sample to the mesh results in dissolution of the mesh coating material into the sample, reducing sample surface tension and allowing sample to wet the whole of the sensor area. Sample may not flow over the sensor area in the absence of a wetting reagent coated onto the mesh. Alternatively, in complex samples such as blood, where the measurement of a specific analyte is adversely affected by the presence of whole cells, for example by occluding an electrode surface, the mesh may be coated with one or more agents which lyse the cells on contact, this has the added advantage of reducing sample viscosity at the same time as removing the whole cell interference.

The system may be deposited as a single electrode, a microelectrode or as a microelectrode array. The electrode may be used in conjunction with reference/counter electrodes deposited on the same substrate.

The non conducting substrate material may be a sheet of for example, polyester, polycarbonate, polyvinyl chloride, high density polypropylene or low density polypropylene. In a preferred embodiment, a polyester sheet material is heat-stabilised prior to application of the conducting layers, to confer dimensional stability on the polyester material prior to processing.

The conducting layer preferably contains graphite, carbon and a polymer binder. For example, the graphite component has an average particle size of up to 20 μm, e.g 1-20 μm, a surface area that is typically of up 50 m²/g, e.g. 1-50 m²/g. It is inherently conductive; it may be derived from either natural sources or produced synthetically. The carbon component preferably has an average particle size of less than 1 μm, eg. 5-70 nm, and typically has a surface area of less than 150 m²/g. Like the graphite component, it is also inherently conductive.

The polymer binder may be either thermoset or thermoplastic. It may be derived from any of diverse polymer families, including polyvinyl chloride, polyvinyl acetate, polyvinyl alcohol (and copolymers of vinyl chloride, vinyl acetate and vinyl alcohol), hydrocarbons, ethyl and methyl celluloses, epoxys, polyesters and alkyds. Suitable polymers may contain functional, reactive groups such as carboxyl, hydroxyl, amine, thiol ester, epoxide and/or amide groups, which enable the polymer to be cross-linked.

The conducting electrode material may be deposited on the non-conducting substrate by a conventional printing process, e.g. thick film printing (also known as screen printing), lithography, letterpress printing, vapour deposition, spray coating, ink jet printing, laser jet printing, roller coating or vacuum deposition. Following deposition of the conductive electrode material, the polymer binder may be stabilised or cured by a number of conventional processes, including forced air drying, e.g. at elevated temperatures, infra-red irradiation, ultraviolet irradiation, ion-beam irradiation and gamma irradiation. All of these processes result to varying degrees in the cross-linking of individual molecules of the polymer binder. The use of ultraviolet radiation typically requires the inclusion of a photo-sensitising reagent in the conductive electrode material, to initiate the polymer cross-linking reaction.

The reagent located on top of the first conductive layer usually it contains all the components, in a solid state, necessary for measuring the concentration of analyte in a sample Examples of suitable such components include enzymes, enzyme cofactors, coenzymes, co-substrates, antibodies or other analyte-binding partners, DNA or RNA, redox partners, mediators, buffers, ionophores and salts.

The reagent may also support matrices, binders and stabilisers for the other components. For example, suitable matrices include particles of graphite, carbon, silica, glass, latex or polyvinyl chloride. Suitable binders include polyvinyl alcohol, polyvinyl acetate, polyvinylpyrrolidone, proteins, cellulose and cellulose acetate. Suitable stabilisers include alcohols, esters, proteins, protein hydrolysates and both simple and complex carbohydrates.

The reagent may comprise a number of individually applied layers, each containing specific components. Its composition is such that it undergoes at least partial dissolution when contacted by the fluid sample.

The reagent may be deposited on the first conducting layer by a conventional deposition process, e.g. thick film printing (also known as screen printing), lithography, letterpress printing, vapour deposition, spray coating, ink jet printing, laser jet printing, roller coating or vacuum deposition. Alternative deposition methods include syringe displacement, pump displacement and titration; such methods are common in the art. Combinations of these deposition processes may be used to construct a multilayer device. Following deposition of the reagent (or after deposition of each individual layer), the layer may be stabilised or cured by a number of conventional processes, including those described above, in order to achieve cross-linking of individual molecules of the polymer binder.

The spacer layer may be deposited on the first non conducting substrate by conventional thick film deposition, and may be stabilised or cured by a number of conventional processes, including those described above, in order to cross-link individual molecules of the polymer binder. The thickness of the spacer layer may be controlled by means of a number of parameters, including printing conditions (pressure, speed, screen tension and emulsion thickness and ink properties such as solids content and viscosity.

Electrodes of the invention have several desirable characteristics. For example, the devices require a ver small volume, typically less than 1 μL, e.g. down to 100-200 nL, of sample such as whole blood, plasma, serum, interstitial fluid, sweat or saliva. When the sample fills the sample cavity, a very thin film of sample is spread across the surface of the deposited reagent, maximising contact with the reagent, and enabling reagent to be dissolved in the sample rapidly. This allows rapid attainment of the steady state.

In a preferred embodiment of the device, the cavity is positioned at the end of edge of the device. This device may be readily filled with sample by contacting the edge of the test strip with the sample. In another preferred embodiment, the cavity may be positioned 0-2 mm from the edge of the device, thus exposing an area of the test strip which may be scraped along a surface (such as a punctured area of skin), in order to collect the sample.

In accordance with this invention, any one or more of the components of a redox reaction, e.g. an enzyme such as glucose oxidase or glucose dehydrogenase, a co-factor and a mediator may be applied to a mesh or membrane which is placed over the device. For the purpose of illustration only, the invention may be described with reference to an enzyme-coated mesh. Whichever component or components are used, when the sample is added, they are solubilised quickly and form an efficient reaction medium that can provide contact between the separate electrodes of the test strip. In this manner, the reaction will proceed rapidly. This reaction configuration is particularly indicated in cases where the sample volume is low, the sample is viscous (such as with whole blood) and a rapid reaction is required.

In a typical embodiment of the invention, the sensor test strip consists of two electrodes one of which acts as a working electrode and another which acts as a counter, reference electrode. The end of the working electrode that is exposed to the sample has a mediator in intimate contact with it. The test strip effectively provides a reaction chamber defined by these two electrodes and an additional sheet, overlying the electrodes, which has been pre coated with the redox enzyme and any necessary cofactor for that enzyme. The reaction chamber may also comprise further sheets of material and/or wetting agents, e.g. a surfactant, or cell-lysing materials (which may be placed in any one of the overlying sheets). In this manner, the active enzyme is not coated onto the conductor which forms the working electrode but is provided in a separate layer above it which, in turn, effectively forms the solution phase of the reaction chamber. When combined with lateral flow, conditions are created that approach efficient mixing in a stirred reaction chamber.

In an example of the invention, a silver chloride/silver reference/counter electrode is located adjacent to a carbon electrode. Typically, for this purpose, a pair of printed carbon electrodes is printed on a non-conducting substrate, and then silver/silver chloride is printed on one of the carbon electrodes to function as the reference/counter electrode. A non-conducting ink is printed over the carbon electrodes and the substrate, in order to define a portion of each electrode as a contact pad for insertion into a meter and another portion on each electrode away from the contact pad as the sensing area where the sample is received.

A mediator for the enzyme cofactor NADH is then prepared and deposited onto the electrode form aqueous by solution pipetting. A further layer containing NAP is then deposited onto the working electrode.

A monofilament mesh material is coated with a surfactant and then with a solution containing glucose dehydrogenase via pipetting, ink jet-coating or dip coating, and is placed over the two electrodes to form a reaction chamber. This reaction chamber may be defined further by additional printing, or by the use of a top layer to form an edge fill cavity. For example, a second non-conducting ink printed on top of the mesh maternal, and then a cover tape is applied on top of the mesh in such a way as to leave an extended area of the mesh exposed for sample application.

The device allows the application of a small volume of sample (typically 1 μL or less) to the mesh extension. This is followed by flooding of the device sensing area with sample, bringing it into intimate contact with the measuring electrodes.

In more detail, the drawings show a non-conducting sheet 1 and, deposited thereon, a conducting electrode in two parts 2a, 2b. The part 2a carries a reference/counter electrode 3, and the part 2 carries a reagent layer 5. The pans 2a, 2P also carry a spacer layer 4 (this and other components described below are not shown in FIG. 1B, which is provided merely to show the electrical configuration). A mesh material 6 is laid over the electrode 3, the spacer 4 and the reagent layer 5. A tape 7 is provided over the mesh material 6.

A device sensing area 8 is defined between the respective parts of the conductive layer and thus between the reagent and the reference electrode. The mesh material is not coextensive with the tape 7, thereby defining a sample application area 9. In use, sample applied to area 9 is carried by the mesh 6, so that it floods areas 3, 5 and 8. The presence of an analyte in the sample can now be determined electrochemically.

In such a device, reagent is preferably provided on the mesh material Such a device can work by application at its edge, to a sample. This is particularly valuable in cases where it is difficult to extract the sample. Other configurations will be evident to one skilled in the art, including combinations of one or more of the cofactor, mediator or the enzyme coated onto the overlying mesh or membrane sheets. The choice of combination may on the reaction kinetics of the various compounds

In another embodiment of the device, the enzyme or the mediator is coated on the sheet, the co-factor and/or the enzyme are coated onto the working electrode directly, and the sheet is capable of filtering the whole blood such that the active electrode se a sample which is effectively free of whole blood cells. In this case, the haematocrit dependency of the result is substantially reduced. In this manner, the cell-filtering function of a selected membrane may be combined with the rapid kinetics of having the some or all of the active elements of the reaction (the enzyme, mediator and the co-factor) in the membrane, to produce a highly effective device.

In another embodiment of the device, the enzyme and mediator are coated onto the working electrode directly, and the sheet is coated with surfactants and a cell-lysing agent such that the active electrode sees a sample which is effectively free of, or has substantially reduced levels of, whole blood cells. In this case, the haematocrit dependency of the result is substantially reduced.

In summary, according to the present invention, a device may be constructed by depositing one or more of the reagents required for the quantitation of an analyte as a single or multiple layers on a fine mesh material or membrane, the deposited areas are of dimensions small enough to wet with a very small sample volume. The mesh or membrane can be used in both calorimetric and electrochemical devices. Alternatively, one of these reagents is coated onto the active electrode.

A characteristic of this invention is that a reagent is applied precisely onto a target area, or covers a target area, on a woven material such as polyester or nylon or other porous membrane. In use, this provides rapid solubilisation of the reagents in the presence of the sample. The reagent or reagents can be applied in a number of different methods that result in the deposition of a known volume at a precise location and in a well-defined foot-print. These include the use of dispensing equipment such as a piston pump, syringe pump or on-demand ink-jet printer. Alternatively, the whole mesh may be coated via dip coating or spraying.

The present invention particularly provides for the construction of a glucose-sensing patch in which the enzyme is dried upon a non-absorbent mesh material that can be overlaid onto an electrode surface. Contact between the electrode/mesh and the skin can be achieved by a hydrogel or other conducting polymer. In this manner, the hydrogel and the enzyme-supporting layer are kept separate from each other until use. In addition, the gel layer can be manufactured without having to incorporate a delicate enzyme that may be damaged by cross-linking or other processes involved in the manufacture of the hydrogel.

The hydrogel may be wetted by rupturing a small reservoir before use. Alternatively, the hydrogel may be clipped into place over the electrode and mesh assembly before use.

In a further embodiment, a flexible tape containing one or more reagents may be laminated to another flexible tape on which is printed a series of electrodes. Instead of cutting out individual sensors, the laminate (comprising a raw or series of sensors) may be used sequentially e.g. on being dispensed from a suitable dispenser. For this purpose, whether or not as a laminate, a tape of the invention may be provided as a roll, and stored in sealed cassettes which may also contain desiccant. In use, the cassette may be inserted into a automatic dispenser from which the tape is wound out automatically by an indexing mechanism to reveal sequentially the discrete sensors. The action of this instrument is therefore analogous to the action of a film in a camera. In this embodiment, the tape may also contain a red blood cell-lysing reagent such as degitonin or saponin, in order to reduce the effect of haematocrit and haemoglobin in a whole blood sample. The tape may be further protected from moisture by being covered with a peelable film (e.g. of aluminum) that is automatically peeled off when the tape is dispensed from the cassette. When the sample is applied to the sensor, the amount of analyte of interest in the sample may be determined electrochemically. Such determination can be conducted by known methods.

Electrodes of the invention may be used for the analysis of analytes/species which can be directly oxidised or reduced by the removal or addition of electrons at an electrode; analytes/species which can be readily converted, by an enzyme or a series of enzymes, to a product which can be directly oxidised or reduced by the removal or addition of electrons at an electrode; analytes/species which can be converted to a product by an enzyme, with the concomitant oxidation or reduction of an enzyme cofactor, wherein the cofactor may then be directly oxidised or reduced by the addition/removal of electrons; and analytes/species which can be converted to a product by an enzyme which is in intimate contact with the electrode surface, such that the enzyme is able to pass or receive electrons directly from the electrode. The novel device is particularly suitable for use as a glucose sensor. In this case, the reagent is preferably glucose dehydrogenase, this can provide a glucose reading that is substantially independent of the haemocrit of the sample.

In a further embodiment of the invention, the electrode strip may be attached to a means for automatically obtaining a sample, e.g. from the body of a patient. In this embodiment, suitable means such as a catheter, needle or sharp capillary fill channel is in contact with the strip, such that sample may be obtained and wick automatically into the device. The user does not therefore have to carry out separate steps of obtaining the sample and applying the sample to the strip.

The strip electrode can be used with any fluid in which the analyte to be determined is present including, but not limited to, interstitial fluid, saliva, whole blood, plasma, serum, urine, tear drops, sweat, exudate, non-ological fluids cell extracts and fruit juice.

The following Examples illustrate the invention.

### EXAMPLE 1

A conductive ink material is printed onto a non-conducting polyester sheet material (125 μm thick) by a screen printing-process. The conductive ink material consists of a mixture of graphite particles (average particle size 1 μm, with a surface area of 15 m²/g), conductive carbon particles (average particle size 40 nm, surface area 100 m²/g), and a vinyl chloride/acetate copolymer binder in an organic solvent. After deposition of the conductive ink, solvents are removed in a forced air oven, whilst the application of elevated temperature initiates the chemical cross-linking of polymer binder by the bifunctional amine

A silver/silver chloride, screen-printed reference/counter electrode is located adjacent to the conductive carbon layer on the polyester support. A spacer layer is then screen-printed in such a way as to leave part of the conductive carbon electrode and all of the reference/counter electrode exposed.

A multilayer reagent mixture, specific for the measurement of glucose, is prepared. It comprises 2,6-dichlorophenolindophenol, Nile Blue, Medola Blue or any other suitable mediator for the enzyme cofactor NADH, deposited onto the exposed conductive carbon/graphite layer from aqueous solution by pipetting, and dried to leave a film of mediator coated onto the conductive carbon/graphite layer. As the electron acceptor. Medola Blue is preferred; see U.S. Pat. No. 4,490,464. A second layer is deposited by thick film printing, consisting of a mixture of graphite, NAD⁺, buffer salts, surfactants, stabilisers and rheology modifiers. This is then dried. A third layer is deposited by pipetting, consisting of an aqueous solution of glucose dehydrogenase (NAD-dependent), lysing agents and stabilisers. That is then also dried.

A surfactant-coated monofilament mesh material is located on top of the spacer layer and secured by thick film deposition of a second spacer layer. In addition, this layer may be coated with saponin/DNMG, in order to lyse red blood cells.

A second non-conducting layer, comprising a 75 μm thick polyester tape material, is adhered onto mesh material with a pressure-sensitive adhesive and is positioned on top of the monofilament mesh in such a way as to leave an extended area of the mesh exposed. The exposed area acts as a sample application zone.

When a suitable potential difference is applied between the conductive carbon and the silver chloride reference electrodes, the electrode device can be used for the measurement of glucose in a sample of blood, using standard electrochemical techniques such as chronoamperometry. Glucose is converted to gluconolactone, with concomitant conversion of NAD⁺ to NADH by the action of the NAD⁺-dependent glucose dehydrogenase, and NADH is reoxidised to NAD⁺ by the mediator compound. The mediator compound is in turn reoxidised at the electrode surface, and the current produced is proportional to the concentration of glucose in the sample.

### EXAMPLE 2

A conductive ink material is printed onto a non-conducting polyester sheet material by a screen-printing process. The conductive ink material consists of a mixture of graphite and carbon particles and a polymer binder in an organic solvent. After deposition of the conductive ink, solvents are removed in a forced air oven. A silver/silver chloride reference/counter electrode is printed onto one of each pair of printed carbon electrodes followed by a non-conducting ink layer to define the contact pads and the sensor area.

A mediator such as Meldola Blue, Nile Blue or other suitable dye and the enzyme co-factor nicotinamide adenine dinucleotide (NAD) are deposited onto the carbon electrode Alternatively, the NAD is applied separately over the mediator from an aqueous ink.

The enzyme glucose dehydrogenase is deposited as uniform spots an monofilament polyester mesh tape. This is achieved as follows:
(a) in a contact mode, where a drop formed at a dispenser tip in close proximity to the mesh is allowed to be transferred to the mesh by touching off the drop onto the mesh surface; or
(b) in a non-contact mode, where a drop formed by an ink-jet print-head or other orifice above the mesh is dropped onto the mesh from a distance under conditions which do not cause it to penetrate the mesh.

Upon drying, the spots spread to cover an area defined partly by the characteristics of the mesh weave and partly by the application conditions. Typically the areas covered by a 500 nL drop is 1.3×1.2 mm. The mesh tape is allowed to dry at room temperature.

The enzyme-modified mesh tape is then laminated onto the modified sheet of devices and secured further by a non-conducting print. Finally, a cover tape is laminated on top of the mesh. The sheets of devices are disc cut into individual devices. In an alternative device format, the laminated sheets are wound and included in a cassette type unit, allowing a single device to be used by a wind-on mechanism similar to a camera film-winding system.

### EXAMPLE 3

Experiments were conducted, to demonstrate that the present invention allows the production of glucose sensor strips that are essentially independent of the haematocrit of the blood sample. A comparison study was carried out between three batches of glucose sensors. The sensors were constructed as per Example 2, i.e. the enzyme is dispensed on a polyester mesh material before application to the sensor devices. In this case, batch 1 was made with no addition to the enzyme and acts as a control, batch 2 was prepared by dosing onto the mesh an enzyme solution containing 1% saponin and 0.5% decanoyl-N-methylglucamide from which low molecular weight components had been removes, and batch 3 was made by adding 1% pure digitonin to the enzyme before application to the mesh.

The three batches of sensors were tested with blood samples having various glucose concentrations and haematocrits ranging from 20-60% The results obtained showed that there was a strong dependence on haematocrit for batch 1 where no lysing agent was present Batch 2 and batch 3 showed that there was a reduced dependence on haematocrit in the presence of lysing agents, over the haematocrit range of 20-60%.

### EXAMPLE 4

Glucose oxidase is dissolved in water. The solution is pipetted onto a fine polyester mesh such that it wicks over the entire mesh and is in slight excess. The mesh is then dried under an air flow.

The mesh is cut out, to cover an electrode surface. Hydrogel is applied to cover the mesh and electrode, and pressed down well. A sample-retaining mount of the mesh and hydrogel is applied, such that all layers are held down onto the electrode backing surface 20 μl phosphate buffered saline is added. Conditioning procedure is applied, before testing response to glucose.

1. A test strip comprising:
a support carrying an active electrode and a counterelectrode; a layer of a mesh or membrane material within which a small volume of liquid to be tested can be distributed and provide contact between said active electrode and said counter electrode, and wherein an analyte-specific reagent is coated on said material or on one of said electrodes; and
which includes a sample application area at one edge of the mesh or membrane.

2. The test strip according to claim 1, wherein said reagent is at least one component of a redox reaction.

3. The test strip according to claim 2, wherein said at least one component is one or more of an enzyme, a mediator and/or cofactor for the enzyme.

4. The test strip according to claim 2, wherein said at least one component comprises an enzyme.

5. The test strip according to claim 4, wherein said enzyme is selected from the group consisting of glucose oxidase and glucose dehydrogenase.

6. The test strip according to claim 1, wherein said material is a monofilament mesh or membrane.

7. The test strip according to claim 1, which additionally comprises a spacer layer deposited over said electrodes.

8. The test strip according to claim 7, wherein said mesh or membrane material is a monofilament mesh coated with a surfactant or chaotropic agent, the mesh being laid over the reagent, the reference electrode and the spacer layer; and wherein the test strip additionally comprises a second non-conductive layer, adhered to the mesh layer, but not coextensive therewith, thereby providing a sample application area at one edge of the mesh.

9. The test strip according to claim 1, wherein said reagent is free of filler having both hydrophobic and hydrophilic surface regions

10. The test strip according to claim 8, wherein said mesh is additionally coated with a cell lytic agent.

11. The test strip according to claim 10, wherein said cell lytic agent is selected from the group consisting of digitonin, saponin, DNMG and combinations thereof.

12. The test strip according to claim 1, wherein said electrodes comprise graphite particles, carbon particles and a polymer binder.

13. The test strip according to claim 12, wherein the graphite particles have an average size of 1-20 μm and a surface area of 1-50 m²/g, and the carbon particles have an average size of 5-70 nm and a surface area of less than 150 m²/g.

14. The test strip according to claim 1, in combination with means for obtaining a sample, such that the obtained sample passes directly to the sample application area.

15. A method for testing a liquid for the presence of an analyte, which comprises contacting the liquid with a test strip according to claim 1, and detecting the current.

16. The method according to claim 15, wherein the liquid is blood and the analyte is glucose.

17. A flexible tape of a material within which liquid can be distributed and on which are coated discrete areas of at least one component of a redox reaction.

18. The flexible tape according to claim 17, wherein the material is a monofilament mesh or membrane.

19. A container containing a wound tape according to claim 17, and optionally also comprising automatic dispensing means.
